(19) United States
(12) Patent Application Publication
(10) Pub. No.: US 2016/0195190 A1
(43) Pub. Date: Jul. 7, 2016

(54) Media Control Valve

(71) Applicant: Phuong Taylor Nguyen, Richmond, TX (US)

(72) Inventor: Phuong Taylor Nguyen, Richmond, TX (US)

(21) Appl. No.: 14/561,159

(22) Filed: Dec. 4, 2014

(51) Int. Cl. F16K 1/32; F16K 3/24

(52) U.S. Cl. CPC F16K 1/32; F16K 3/246

(57) ABSTRACT

A media control valve includes a body, a plunger assembly of multiple components housed in the body with a plunger control valve cap assembly secured to the body for housing a control knob. The body and the plunger assembly include resilient seals between adjacent multiple components of the body and the plunger assembly, respectively, to permit relative movement therebetween during assembly and use. The media control valve includes a diaphragm which acts as a membrane that physically isolates and seals the chambers above and below. The spool design of the valve has all of the seals and bushings held within the spool. Once the spool is removed, the replacement seals and bushings can be replaced and inspected with relative ease due to the accessibility at both ends of the spool. Since each plunger seal is held within its own rigid cavity, held on three sides and not stacked on top of another seal or loose component, proper alignment is better assured during and after installation. The body components parts are also assembled using resilient seals to facilitate assembly and repair, while reducing any tendency of the valve to seize during use.

### REFERENCE TO RELATED APPLICATIONS

Reference to related Applications. This application is a continuation-in-part of the U.S. patent application Ser. No.: 13/286,206, entitled “Modular Control Valve” filed on Oct. 31, 2011, now U.S. Pat. No.: 8,827,243 issued Sep. 9, 2014, and a continuation-in-part of copending U.S. patent application Ser. No.: 14/177,224, filed on Feb. 11, 2014, which is also a continuation-in-part of U.S. patent application Ser. No.: 13/286,206. Said applications are fully incorporated by reference herein. Full priority to the filing date of Oct. 31, 2011, as applicable to previously disclosed material therein is claimed herein.

### BACKGROUND

1. Field of the Invention

The present invention is related to media control and more specifically, media control valves used to control the flow of a media into a fluid stream as part of an apparatus for treatment of a surface.

2. Description of the Related Art

A typical manual media control valve is disclosed in U.S. Pat. No. 4,322,058 (“the '058 patent”). The valve of the '058 patent is attached to a media vessel and controls the flow of the media from the media vessel into a conduit containing a fluid stream. This conduit terminates in a nozzle. Fluid and media pass through the nozzle at high speed and are typically used to treat surfaces.

A more recent pneumatic actuated media control valve is the pipe side valve shown and described in U.S. Pat. No. 3,476,440 (“the 440 patent”), issued to Thompson, et al on Mar. 30, 1982. The valve described in this patent has been has been widely accepted in applications where the flow of particulate material, particularly abrasive material, from a tank or hopper, is fed into a blast line for propelling the particulate material or media through a nozzle.

As shown in the '440 Patent, the valve has a unitary plunger which is movable axially with respect to a lateral particulate material inlet between positions closing and opening the inlet. The plunger is moved by pneumatic or spring force against the piston. The valve body passage through which the plunger is disposed, and the plunger itself, are formed to have abrasion resistant surfaces. A lateral air pipe nipple sealed to the valve body receives the abrasive material flowing through the valve for use in blasting operations.

Various improvements to the basic media control valve have been proposed. For example, U.S. Pat. No. 5,407,379 (“the '379 patent”) and U.S. Pat. No. 5,401,205 (“the '205 patent”) disclose media control valves having a media passage between the media control valve and the conduit. The media passage converges into a slot-shaped outlet in the conduit so as to reduce the perimeter of the outlet placed perpendicular to air flow and consequently reduce turbulence as air passes across the outlet. The media control valves disclosed in the '205 and '379 patents are particularly useful in metering and dispensing sodium bicarbonate media.

Over the years many modifications to media control valves have been proposed. For example, U.S. Pat. No. 5,810,045 (“the '045 patent ”) discloses a pneumatic actuated metering control valve for introducing particulate materials into a high-pressure air stream and suggests several uses for this valve, such as, by way of example, introducing fluid catalytic cracking catalyst particles into fluid catalytic cracking units used to crack and reform various petroleum based products, introducing particulate catalysts into other kinds of chemical processes and spraying particulate ingredients on adhesive substrates as part of various manufacturing processes.

U.S. Pat. No. 5,407,379 (“the '379 patent”) and U.S. Pat. No. 5,401,205 (“the '205 patent”) disclose a pneumatic actuated media control valve having a media passage between the media control valve and the conduit. The media passage converges into a slot-shaped outlet in the conduit so as to reduce the perimeter of the outlet placed perpendicular to air flow and consequently reduce turbulence as air passes across the outlet. The '045 patent also includes the use of multiple seals around a plunger of the valve with an exhaust therebetween to remove any contaminants that breach the seals.

Another type of valve used in the industry is the manual metering valve shown and described in my U.S. Pat. No. 7t549t911, entitled: “Media Control Valve with Pressure Balance Loop”. The valve there shown incorporates a bypass loop for equalizing pressure during startup operation. Specifically, the valve includes a pressure fluid inlet upstream of the valve media outlet. When the valve system is off, the system is typically depressurized. In typical applications, a backflow into the valve is caused by the fact that on startup the pressure increase in the media tank is at a slower rate than the pressure increase in the blast line. Thus, there is a backflow from the blast line into the valve until both the media tank and the blast line pressures are equal. This continues until the valve is again equalized with the media flowing through the valve and into the pressurized fluid stream. The valve so disclosed incorporates a balancing or equalizing pressure loop for minimizing or reducing the backflow of pressurized fluid into the valve through the media outlet port during startup. The valve also includes a cleanout port for cleaning out debris that may obstruct media flow and residue media after use. This permits clean out of the valve without disassembly. The ability to clean out the valve after use further reduces wear and tear on the valve and minimizes maintenance and repair.

Despite the various improvements in myriad valve designs for a variety of applications, the valve disclosed in the Thompson patent is to this day a widely accepted valve for blasting operations. As desirable as this valve is, there remains room for improvement, especially with respect to reliability, as well as repair and maintenance of the valve.

One of the most critical issues with remote actuated media control valves is the life of the valve. The abrasive media can damage the valve beyond use in a short period of time, requiring replacement or substantial repair. Many of the valves of the prior art, as particularly shown in the '440 and '045 patents, typically have a spool that consists of a sleeve (tungsten carbide or hardened steel) made of a softer material. In these configurations, the hard sleeve and bonded with stainless steel with the ID of the sleeve being flush with the ID of the hard jacket 12 of the spool 11. The valve plunger is of the same type construction, except that the sleeve is a hard material and the inside is a softer more workable material. It is not uncommon for any of these valves to malfunction after some use due to the spool and plunger locking up, thereby not allowing the plunger to reciprocate within of the spool. In some cases, solid hardened spools are utilized. In either case when plungers lock up or seize, accelerated wear results on the adjacent components of the valve such as the body, seat, and base.

The '045 patent purports to keep particulates from entering the cylinder chamber, and thereby improve the life of the valve. However, this patent does not address the more frequent mode of failure where the plunger binds against the spool, or is seized. A gap is required for assembly of the plunger into the spool. Any feasible designed gap will allow migration of particles smaller than the gap. In addition, as the plunger and spool are abraded, the gap will become progressively larger and allow larger abrasive particles to migrate.

Most, if not all of the prior art valve designs use a plunger spool design. All of these valves place the plunger seal(s) above the spool. While these designs have been effective at sealing, there are two issues. First is the accessibility of the seals. Many of these valves use a single plunger seal above the spool which is relatively easy to access but sometimes requires a user to completely remove the valve to properly replace the plunger seals. More recent valve designs include up to three plunger seals with an external o-ring. At least one prior art valve has four plunger seals with a stainless steel bushing stacked above the spool. In many of these valves it is very difficult to change out the seals due to the deep location of the seals with the inherently gritty environment. In valves utilizing the multiple plunger seal design, the plunger seals are stacked on top of each other which is a blind install that does not permit visual verification of proper seal alignment or seal installation. Also, this will create boundaries where two soft surfaces press against each other, which creates an opportunity for the seals to misalign when stressed during plunger movement or during installation or operation.

It has been determined that this seizing can be attributed to several factors. First, the stainless sleeve on the spool wears at the ID more quickly than at the hard jacket primarily because of the difference in hardness of the two materials. This creates a beveled surface between the spool stainless ID and plunger OD where particles would cause binding. Second, the stainless 10 section of the spool is softer than some of the abrasive media used, such as aluminum oxide grit or hardened steel grit. These harder particles can dig into the relatively softer yet still rigid stainless steel and cause binding between the plunger and spool.

Third, this design permits the accumulation of grit within the plunger-to-spool gap. The reciprocating motion combined with the location of the plunger, spool, and diaphragm of this valve and its many variations results in a scooping effect that over time will bind this type of valve. Each time the valve is actuated, a small amount of grit or abrasives, smaller than the plunger to spool gap, is scooped or dragged upward in between the spool and plunger. When the pneumatic signal is removed and vented, the plunger returns to the closed position, dragging some of the small grit back but leaves a residual of grit. With each actuation, the residual grit accumulates. After many cycles, the accumulated grit will effectively form a wedge that will bind the OD of the plunger against the ID of the spool. Easily crushable mineral abrasives do not cause as much of a problem as more resilient abrasives such as hardened steel grit and Aluminum oxide. This is a problem with all plunger-spool designs in the air blast industry regardless of their hardness and regardless of their material composition.

Recently, valve designs including an offset spool internal diameter and plunger seals of the spooled spool have been designed in an attempt to minimize the issue by not allowing or significantly reducing the accumulation of residual abrasives. In addition, the grit that does bypass the seals is so small that they polish the OD of the plunger and consequently improve the life of the seals above the first one. This is the benefit implementing the aforementioned offset spool feature with the spool seals.

The current state of the art for these types of valve is a piston actuated design where a compressed air signal is used to apply force against a spring counteracted sealed with piston seals, both within a cylinder. When the compressed air signal is removed, the spring pushes the piston back to its off position which is generally closed. The plunger which is fastened to the piston is what directly opens and closes the abrasive flow.

This design is not tolerant of particulate contamination which is inherent of the dusty and gritty conditions of an air blast environment. This contamination can originate from two sources. First is the ambient environment of the equipment and valve. In the valve as disclosed in the '058 Patent, and its many variations, the ambient dust will be sucked in when the piston returns to the off position. As the piston travels to its off position, the volume above the piston increases and must draw air from an ambient source. As the dust and grit laden ambient air is drawn in, so too is the grit. Many of the prior art valves, try to mitigate this by installing breather vents with particulate filtration varying from 15-90 microns. When the breather vent is sized properly, the particulates that pass through and enter the cylinder are not large enough to cause the piston to jam, or seize. Breather vents are an additional cost and properly sized fine breather vents are even more expensive. Some end users have even tried to replace the vents with cheaper larger micron vents and have experienced failures. The second source of grit contamination is from the compressed signal line. Blast systems with inadequately supplied compressed airflow tend to pull grit from the blast pot or vessel and cause dust and grit to eventually contaminate the compressed air control line. Where the first source originates from ambient and will contaminate the cylinder volume above the piston, the second source of contamination will reside below the piston. Both have the potential to bind the piston against the cylinder wall or accelerate wear of the piston seal(s).

Typically, in the prior art designs, the piston and piston seal do not function efficiently and fail quickly without lubrication. The lubrication is required to reduce the piston-to-cylinder friction and reduces the response time of the valve. While lubrication serves to minimize the wear of the piston seal which is required for proper actuation of the valve, its consistency is like paste when applied. In some cases oil or light fluids are used. Both types of lubrication have a tendency to attract dust which can contribute to the piston to cylinder binding.

Many prior art plunger spool designs utilize a straight cylindrical spool inserted within a straight cylindrical cavity that is slightly larger the outsider dimensions of the spool. Inherent to this design, grit will find its way and reside between the outside of the spool and inside of the valve body. This will significantly increase the force required to remove the spool from the body. Also, due to the straight cylinder and mating cavity, the grit continues to roll and slide which creates friction until the spool is completely removed. This makes disassembly relatively difficult.

Many of the prior art valves use variants of a tungsten carbide plunger fused or joined to a stainless shaft with bolt threads to fastened the piston. Generally the wear on these occur due to the sliding and rubbing of the plunger against the inside of the spool with abrasive grit between them. Consequently, the wear is mainly in this area. Generally, it has been observed that the stainless portion of the plunger is still in good condition. However, since it is fused to the tungsten carbide, the still new stainless is discarded along with the worn Tungsten.

It is desirable to improve on the various prior art designs by incorporating design changes which facilitate maintenance and repair of the valve. As stated, the primary wear portions of the valve are the plunger and the spool. In many prior art valves, the entire plunger assembly must be removed and the valve completely disassembled in order to replace the worn components. Likewise, the spool can only be replaced by disassembling the entire valve.

It is desirable to provide a media control valve permitting more cost effective maintenance by reducing the replacement requirements for those components which are not subject to wear, to provide a more effective body gasket and seal system and to permit easier assembly and disassembly.

### SUMMARY OF THE INVENTION

The subject invention is directed to a media control valve with a valve body having a media inlet and a media outlet and a plunger which is positioned within the valve body. The plunger is connected to a metering control assembly in the bore of the valve body and can be removed without disturbing the control assembly. A spool is positioned in the valve body between the valve body and the plunger.

In one aspect of the invention, the media control valve includes a diaphragm which eliminates the piston and piston seal. The diaphragm acts as a membrane that physically isolates and seals the chambers above and below. The pistonless design means that that there is no piston to slide and seal against the cylinder wall. This results in less sliding friction and eliminates one less area where grit can bind the valve. Dust and grit from ambient or a contaminated compressed air line will not bind the valve. The breather vent becomes less critical. In addition, less friction means more of the mechanical forces are available to open and close the valve resulting in quicker, more efficient, and more reliable valve action. Also, the diaphragm designs do not require lubrication, which speeds assembly time and also minimizes the environmental impact from the lubricant.

In another aspect of the invention, the spool design has all of the spool wiper seals and bushings held within the spool. This allows removal of all of the seals along with the removal of the sleeve. In some cases, not all but some of the seals can be inside the sleeve without departing from the spirit of the invention, which is consistent with one aspect of the invention. Once the spool is removed, the replacement seals and bushings can be replaced and inspected with relative ease due to the accessibility at both ends of the spool. Since each seal is held within its own rigid cavity, held on three sides and not stacked either on top of or below another seal, proper alignment is better assured during and after installation.

It is an important feature of the valve of the subject invention that the rigid assembly between components which is common in the prior art valves has been replaced with a floating design with components being assembled using numerous resilient seals and spacers between rigid members, permitting the assembly to self-center or self-position. This minimizes or even eliminates the tendency of various components to bind during operation, particularly as a result of normal operation and normal wear. This also assures proper alignment of the various components by permitting relative movement between components during operation. The floating design of the subject invention also facilitates in maintenance and repair by permitting the assembly to be disassembled by relying on the relative ease in removing the resilient seals.

Even in prior art designs having a single plunger seal, the spool/sleeve design of the subject invention will allow for additional space to include additional plunger seals or wipers which will improve the life and versatility of these valves, as well. Also, the addition of a properly aligned wiper immediately above the sleeve orifice keeps all the grit between hard-to-hard surfaces, thus reducing sliding friction and preventing the accumulation of residual grit between the plunger and spool. This also reduces the size of the grit that can migrate past the wiper seals.

In yet another aspect of the invention, the composite spool may incorporate a soft urethane or equivalent material to encapsulate a hard abrasion resistant material such as tungsten carbide or hardened stainless steel. The softer thermoplastic spool will allow for easy removal while the hard liner or sleeve will provide longevity, durability and low friction. Revising the cavity to have a taper allows the gap relative to the spool to increase during extraction or removal thus decreasing the bind and rolling and allow the spool to release easily. In addition, a taper, at the same angle as the mating inside surface of the body cavity, can be utilized. This will further ease the release of the spool from the body.

The modular plunger design of the subject invention utilizes fasteners to fix a hardened (example: tungsten carbide) jacket around the softer (example: stainless) plunger core. In this design, the tungsten carbide slides over the stainless with three seals between them and held in place with a bolt screwed into the stainless shaft. The tungsten jacket can be removed and replaced onto the stainless plunger core. This reduces the cost of the replacement part by reusing the stainless plunger core or shaft. In addition, the two o-rings and washer seals allow the tungsten carbide jacket to “float” and find its concentricity within the spool and sleeve. Although the float is small it prevents binding due to misaligned or eccentric spool and plunger centerlines. The softer spool such as urethane, as mentioned above, allows the harder spool sleeve to conform for concentric alignment with the plunger centerline.

In an alternative embodiment, the spool is adapted to be received in the central bore of the valve body, with the plunger positioned in the central bore in communication with the spool assembly. The spool is a substantially cylindrical member having an outer diameter adapted to be received in the central bore and an inner diameter adapted to receive the sleeve liner. The sleeve has an outer diameter adapted to be received in the spool inner diameter and an inner diameter adapted to engage the plunger. There is at least one removable sleeve seal between the spool inner diameter and the sleeve outer diameter. It is desirable to include multiple seals. Typically, the spool sleeve includes a circumferential channel for receiving and seating each seal. In this embodiment the spool wiper seals are placed in the spool above and below the grit release gap. The spool wiper seal and the spool grit release gap work in conjunction to minimize the friction and extend the life of the plunger seals above it by maintaining low friction after multiple cycles. The second and independent spool seal houses wipers, and the grit release gap is above the sleeve liner in close proximity with the metering orifice. The soft spool wiper and gap are only in contact with the hard surfaces of the plunger at both extremes of plunger travel. A tapered spool outer diameter and mating tapered spool cavity may be utilized for ease of valve disassembly. It is also possible to taper only the spool cavity in the valve body and maintain a straight cylindrical spool outer diameter and still achieve improved disassembly features.

The alternate embodiment may also include an elongated chamber in the upper cap assembly for accommodating an extended portion of the valve spring for minimizing bending of the spring axis as it is moved from the released position to the compressed position. Also, mounting bolts may be through bolts, each secured by a nut and passing through the through holes the lower valve body and the base. This minimizes the collection of grit in the mounting holes and assures assembly without having to remove grit or other material trapped in the mounting holes. The abrasive inlet port may be tapered to minimize entrapment of abrasive material as it is introduced into the valve system.

### BRIEF DESCRIPTION OF THE DRAWINGS

FIG. 1 is a front view of a valve incorporating the features of the subject invention.

FIG. 2 is a side view of the valve shown in FIG. 1.

FIG. 3A is a sectional view taken along line 3-3 of FIG. 1, showing the valve in the closed position.

FIG. 3B is a sectional view taken along line 3-3 of FIG. 1, showing the valve in the fully open position.

FIG. 4A is a sectional view taken along line 4-4 of FIG. 2, showing the valve in the closed position.

FIG. 4B is a sectional view taken along line 4-4 of FIG. 2, showing the valve in the fully open position.

FIG. 5 is a view looking in the same direction as FIG. 3a, with the valve in the fully closed position, and with additional component views showing the plunger assembly and the spool assembly.

FIGS. 5A and 5B are fragmentary views take from FIG. 5, showing the plunger assembly and the spool assembly, respectively.

FIG. 6 is a diagrammatic sectional view of the spool and sleeve design.

FIG. 7 is a diagrammatic sectional view, with taper angles exaggerated for clarity, showing the tapered spool release.

FIG. 8 is a diagrammatic sectional view showing the modular plunger design.

FIGS. 9 corresponds generally to FIGS. 4A and 4B and includes additional features further enhancing the performance of the valve, particularly the tapered spool, sectional spool and mated cavity in the lower housing, as well as additional sealing systems.

### DETAILED DESCRIPTION

The plunger and bore assembly in the lower valve body are substantially different from prior art assemblies and for sake of clarity and consistency the following terms are used throughout this application when referring to the plunger assembly and the bore or body cavity components in the valve body:

Valve body 1, which houses the valve plunger assembly, the spool assembly and the lower diaphragm plate.

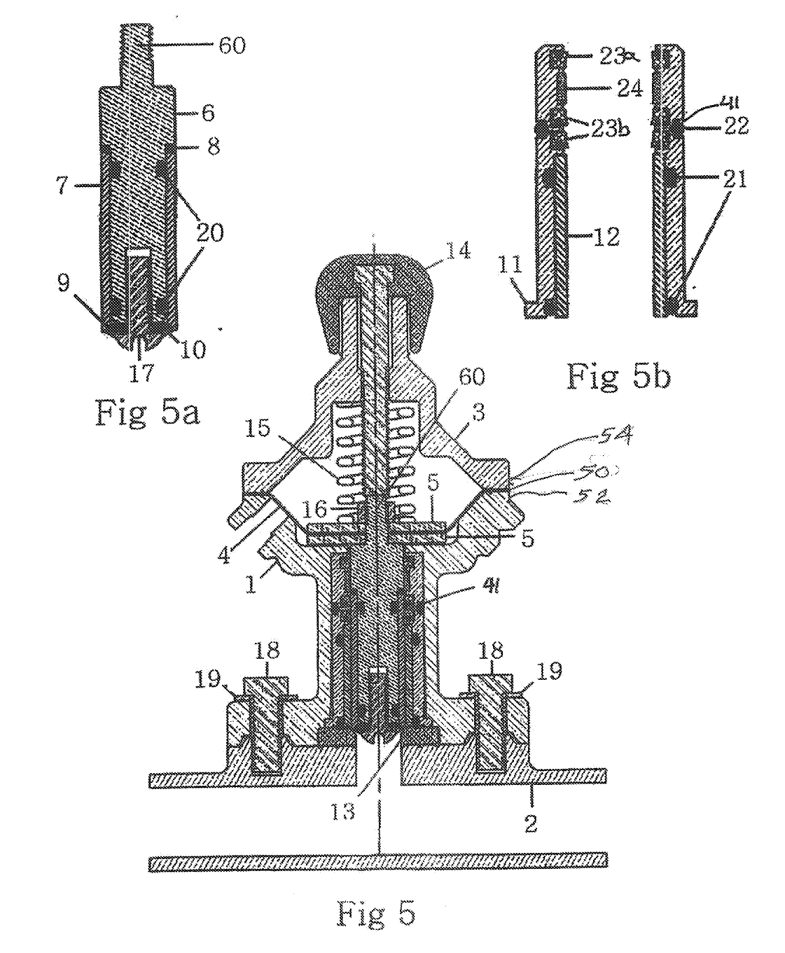

Plunger 6, this is an assembly and comprises the plunger stem 34, the plunger 6, the plunger jacket 7 on the exterior of the plunger 6 and the various seals 8, 20 (FIG. 5a) mounted on the plunger or jacket. The plunger assembly may include a washer or seating ring 10 and a retaining screw or fastener 17 or other securement means for holding the plunger assembly including the sleeve, seals and seating ring in assembled relationship.

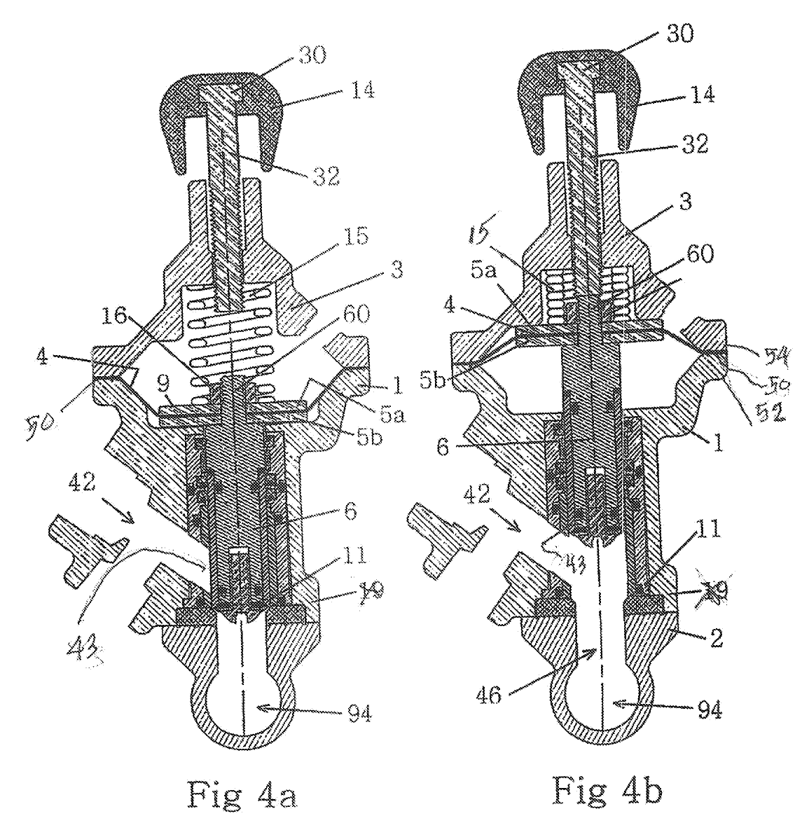

Body cavity 76 (FIGS. 4, 6, 7 and 9, for example) is the central internal cavity of the valve body and houses spool 11 and the spool seals 21, plunger wiper seals 23a,23b and spool wear ring 24. The spool 11 may also include a hardened liner or sleeve 12, permitting the spool 11 to be constructed of a relatively soft material, with the liner or sleeve 12 capable of being made of a different material. The spool seals may or may not be mounted in the liner.

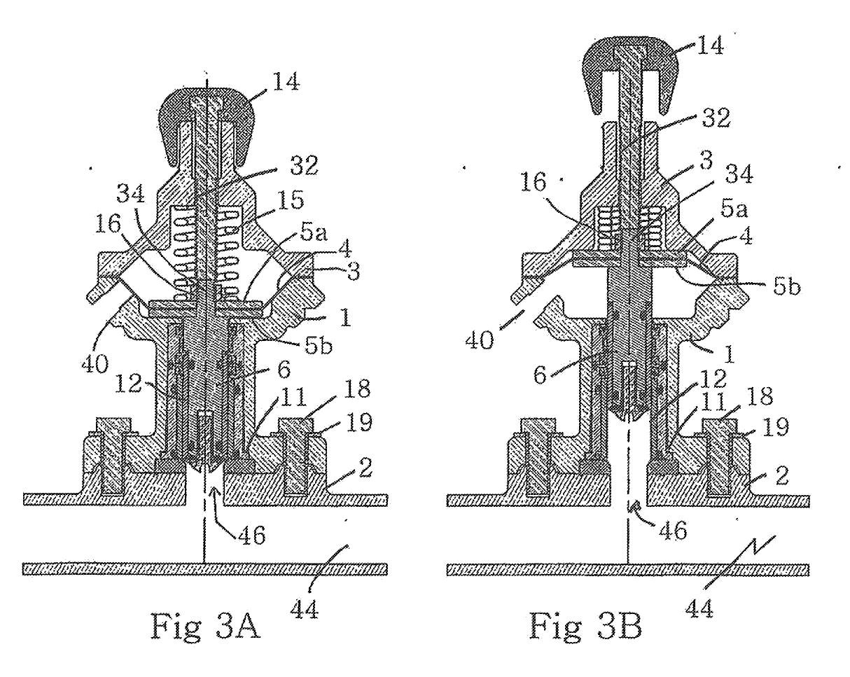

Diaphragm 4 (FIGS. 3A and 3B, for example) replaces the piston of prior art valves and is held between an upper plate 5a and a lower plate 5b secured to the lower valve body 1 and housed in the upper valve body 3. A longer spring retainer 32 is provided to maintain the spring in better axial alignment as it moves from a compressed to an extended position.

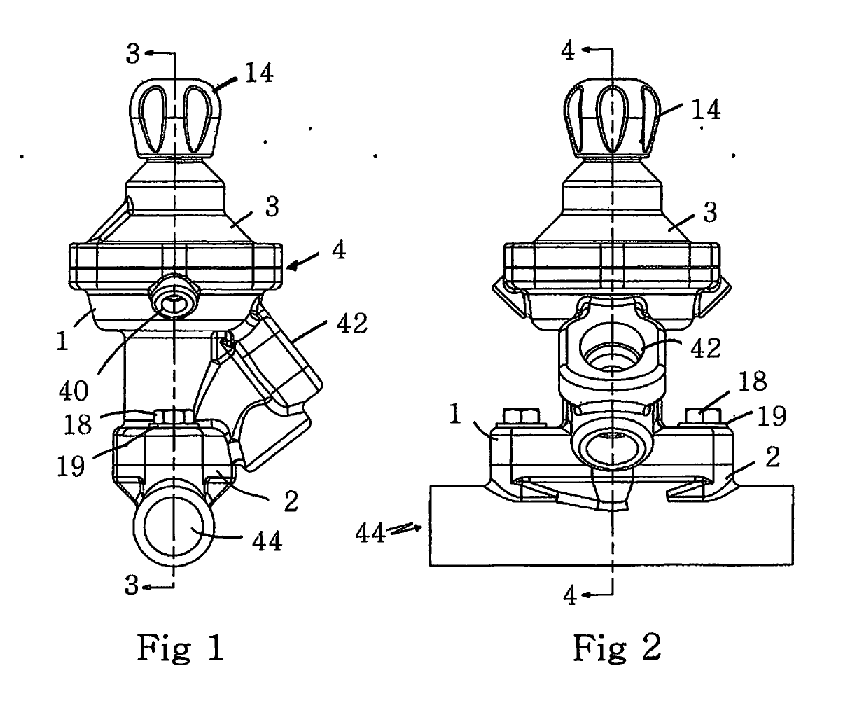

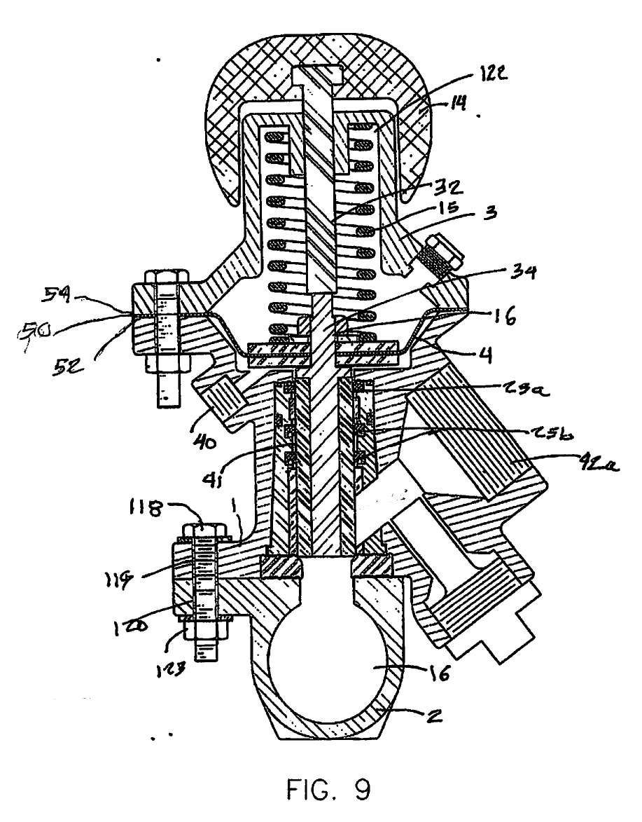

FIGS. 1-8 are of a first embodiment of the invention. FIG. 9, which corresponds generally to the view shown in FIGS. 4A and 4B, includes additional modifications for further enhancing the performance of the valve.

Turning first to FIGS. 1-8, and referring initially to FIGS. 1,2, 3A, 3B, 4A and 4B, the valve assembly includes a lower valve body 1 for housing the valve plunger assembly, the spool assembly and the lower diaphragm plate 5b (see, for example FIGS. 3A and 3B), as will be explained with reference to FIGS. 5-8. The upper valve body 3 houses the valve cap assembly including control knob 14 and is secured to the body 1. The diaphragm 4 (best shown in FIGS. 4A and 4B), upper diaphragm plate 5a and the metering knob assembly terminating in the metering knob 14 are also located in the upper body 3. The upper valve assembly, comprising the body 3, the cap assembly and knob assembly including knob 14 and the internal components are typically secured to the lower valve body 1 by typical means, with the diaphragm perimeter or flange 50 sandwiched between lower valve body 1 and upper valve body 3. The assembled valve comprising the assembly contained in upper valve body 3 and lower valve body 1 is secured to the valve base 2 by a series of bolts or similar fasteners 18. Typically, a washer 19 is positioned between each bolt head and the valve body 1, as shown.

The pressurized indexing air or control fluid is introduced into port 40, as indexed or metered by the position of the metering knob assembly terminating in metering knob 14, which is connected to the metering stem 32. Abrasive media is introduced into the valve at port 42 (best shown in FIGS. 1 and 2). The abrasive media is released into the main flow line 44 in the base 2 through the valve outlet 46 (see FIGS. 3A and 3B). Port 40 is a pneumatic signal port which is controlled from a remote controlled valve. The air pressure and flow through port 40 will allow pneumatic pressure to exert mechanical force onto the diaphragm and lower plate 5b to overcome the spring force and open the valve by lifting the plunger. How much the plunger is allowed to travel is determined the position of the manually adjusted knob assembly 14, which determines how much of the spool orifice 43 and port 42 are opened (FIGS. 4a and 4b), thus controlling abrasive flow.

As stated, in one aspect of the invention, the media control valve includes a diaphragm 4 which eliminates the piston and piston seal. The diaphragm 4 acts as a membrane that physically isolates and seals the chambers above and below. The media control valve includes a body assembly having a valve cap assembly 4 in upper body 3 and a lower plunger body 1. A movable plunger assembly comprising plunger 6 and control stem 60 are housed in the body for axial movement along the substantially central axis of the body. Typically, the valve includes an air inlet port 40. The flexible diaphragm 4 is positioned between the upper cap assembly 3 and the lower valve body 1 and is in communication with the port 40. The flexible membrane or diaphragm 4 is secured to the body and the plunger stem 60 and is adapted for movement with the plunger assembly. In the preferred embodiment, the diaphragm 4 is configured such that its outer edge 50 is sandwiched between the upper and lower body portions 1 and 3. The diaphragm has a central hole through which the plunger stem 60 can pass and the diaphragm is secured to the plunger stem 60 by sandwiching the diaphragm 4 between two mounting plates 5a and 5b. The diaphragm 4 moves between the nested position of FIGS. 3a, 3b and 5 and a metering position of FIGS. 4a, 4b in unison with the plunger 6, as will now be explained.

The valve is shown in the fully closed position in FIGS. 3a, 4a and 5. The valve is shown in the fully open position in FIGS. 3b and 4b. The valve metering system, consisting of the plunger assembly 6, the metering knob assembly 14 is moved to selected positions between the fully closed position and the fully open position by turning the knob assembly in the tapped bore mated with control knob stem 32 in the valve cap assembly 3. When fully open, the knob assembly is extended outwardly from the cap assembly 3, the spring 15 is fully compressed when compressed air enters through the port 40, with the metering bolt or stem limiting the travel of the plunger, as shown in FIGS. 3b and 4b. The media port 42 in the body 1, and in communication with the plunger assembly 6, is also fully open. When signal at port 40 is stopped, the spring 15 acts to push the plunger assembly downward, as drawn, and the plunger closes media port 42, while the diaphragm moves to the position shown in FIG. 4a.

One of the novel features of the subject invention is the diaphragm assembly comprising the diaphragm 4 and the upper and lower diaphragm plates 5a and 5b. The diaphragm 4 includes an outer flange 50 which is positioned between the outer flange 52 of the valve body 1 and the outer flange 54 of the cap assembly 3. The diaphragm is held in assembly when the valve body is secured to the cap. The diaphragm 4 is sandwiched between the upper and lower diaphragm plates 5a and 5b, and secured on the stem 60 of the plunger 6 by a nut or similar fastener 16. The metering knob assembly is rotated into and out of the valve cap. This will permit the plunger 6 to move upward against spring 15 until the stem contacts the know bolt 32, when compressed air is introduced into port 40 as a pneumatic control signal, as previously described, see FIGS. 3b and 4b. When compressed air flow is stopped, the spring 15 forces the plunger down, closing the port 42, see FIGS. 3a and 4a. Port 40 is usually vented to the atmosphere to allow the spring to push the diaphragm back.

The diaphragm design eliminates the piston and piston seal. The diaphragm acts as a membrane that physically isolates and seals the chambers above and below. The pistonless design means that that there is no piston to slide and seal against the cylinder wall. This results in reduced sliding friction and eliminates an area where grit can bind the valve. Also, dust and grit from ambient or a contaminated compressed air line will not bind the valve. The dust filtering vent becomes less critical. In addition, less friction means more of the mechanical forces are available to open and close the valve resulting in a quicker, more efficient, and more reliable valve action. Also, the diaphragm design does not require lubrication, which speeds assembly time and minimizes the environmental impact from the chosen lubricant. In addition, this construction minimizes or even eliminates eccentric binding caused by the cylinder centerline and the cavity center line not being in complete axial alignment, which can happen during wear and is sometimes the case in initial assembly. Specifically, manufacturing tolerances can be loosened without negatively affecting the performance of the valve.

An additional novel feature of the invention is the spool design of the valve. The spool 11 has all of the seals and bushings held within the spool cavity 76 in the central bore of the valve body 1. Specifically, and with particular reference to FIGS. 5, 5b, 6 and 7, the spool 11 is generally but not necessarily constructed of a relatively soft material, such as stainless steel or even polyurethane. The hardened liner or sleeve 12 may be made of tungsten carbide or another suitably hardened material.

The spool 11 is adapted to be received in the central bore 76 of the valve body 1, with the plunger 6 positioned in the central bore in communication with the spool assembly. The spool 11 is a substantially cylindrical member having an outer diameter adapted to be received in the central bore 76 and an inner diameter adapted to receive the sleeve 12. The sleeve 12 has an outer diameter adapted to be received in the spool inner diameter and an inner diameter adapted to engage the plunger 6. There is at least one removable sleeve seal 21(see FIG. 5b) between the spool inner diameter and the sleeve outer diameter. In the preferred embodiment the seal 21 comprises an o-ring. Also, as shown, it may be desirable to include multiple seals 21. Typically, the spool sleeve includes a circumferential channel for receiving and seating each seal 21. It should be understood that the spool and sleeve could be permanently joined if desired.

The outer diameter of the cylindrical spool 11 and the central bore are tapered, shown exaggerated in FIG. 7. In the preferred embodiment, there is at least one removable bore seal 22 (see FIG. 5b) positioned between the central bore of the body 1 and the outer diameter of the spool 11, and may be several, as shown. While shown as on the circumference of the spool 11 in the drawing, see FIGS. 5, 5a and 7, it can also be placed at the top of the spool between the body 1 and the spool 11.

In the preferred embodiment the bore seal 22 is an o-ring. The spool outer diameter includes a circumferential channel for receiving and seating the o-ring (see FIG. 7). It should be understood by those who are skilled in the art that seals other than an o-ring configuration can be employed with equal performance capability. The spool 11 is of longer longitudinal length than the sleeve or liner 12, wherein the portion of the spool outside the sleeve is of an intermediate inner diameter larger than the inner diameter of the sleeve but smaller than the inner diameter of the spool. This creates a gap or void 41 (see FIGS. 5, 5a, 6 and 9) between the spool inside diameter and the plunger and allows the particles in the blast media that migrate past the lower wiper seal to disengage and roll more freely instead of being dragged, as with the prior art.

As best shown in FIG. 5b, at least one circumferential wiper seal 23a is positioned in the intermediate diameter portion and is adapted for contacting the plunger 6 (see FIG. 5, for example). In the preferred embodiment there are multiple seals 23, 23a, 23b and wear ring 24. Circumferential channels may be provided in the intermediate diameter of the spool 11 for receiving and seating the wiper seals 23a, 23b and wear ring 24. In the preferred embodiment the wiper seal 23 is oriented “cup-up”, opposite the two lower wiper seals 23a and 23b which are oriented “cup-down” in order to provide maximum sealing and wiping function.

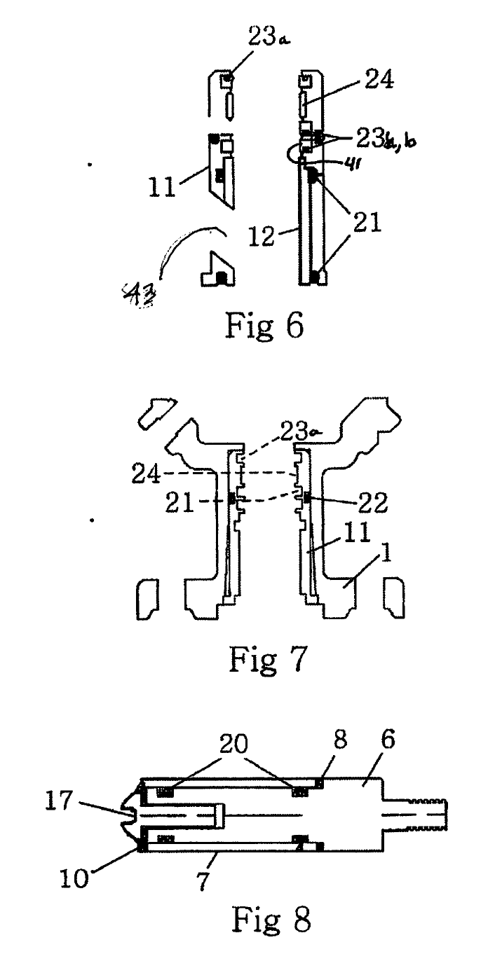

During use of the valve, the wear is primarily on the sleeve 12. In order to facilitate repair and replacement of the sleeve, all of the seals between the spool and sleeve are located on the spool. Specifically, o-ring seals 21 are located on the spool near the top and bottom of the sleeve. As best showing in FIG. 6, packing material, generally of a soft material such as polyurethane or the like is positioned as the wiper seal 23. An integral o-ring 22, as shown, is also mounted on the spool on its outer diameter . An internal wear ring 24 is located on the ID of the spool, above the sleeve 12 and the lower wiper seals 23a and/or 23b. An internal plunger wiper seal 23 is also located on the ID of the spool and positioned above the internal wear ring 24.

This configuration permits removal of all of the seals along with the removal of the spool 11 and sleeve 12 from the valve body 1. Once the spool is removed, the replacement seals and bushings can be replaced and inspected with relative ease due to the accessibility at both ends of the spool. Since each wiper seal 23, 23a and 23b, as well as o-ring or seal 22 are held within their own rigid spool cavity, respectively, and not stacked on top of another seal or mounted as a loose component, proper alignment is better assured during and after installation, replacement and during operation.

Contrary to prior art single plunger/spool seal designs, the new spool design allows for additional space to include additional wipers which will improve the life and versatility of the valve. The addition of the wiper seals 23,23a and 23b above and closer to the sleeve 12 and the metering orifice prevents larger grit from accumulating above carbide-to-carbide surfaces on the sleeve 12 and the plunger wear surface 7 (see FIGS. 5, 5A and 8), thus reducing sliding friction and minimizing one cause of binding. The fine grit that accumulates in the grit release gap 41 will polish the plunger surface that comes into contact with the gap. The polished plunger section results in reduced friction and also reduces wear on the wiper and wiper seals that are in contact with the plunger. .

Prior art designs, such as, by way of example, the configuration shown in U.S. Pat. No. 7,300,336, permit the fine grit to pass the wiper and accumulates in the gap 41 between the plunger and spool and roll instead of slide. Using the configuration of the subject invention it has been found that a super hard grit such as aluminum oxide polishes the surface of the plunger in contact with the gap. The resulting polished plunger surface improves plunger wiper seal life, valve life, and further reduces sliding friction with use.

With reference to FIGS. 5, 5a, 5b and 6, it should be noted that the configuration of the subject invention permits the use of a soft urethane or equivalent material for the spool 11, while the liner 12 may be made of a hard abrasion resistant material such as tungsten carbide or hardened stainless steel. The softer thermoplastic material will allow for easy removal whereas the hard sleeve or liner 12 will provide longevity and durability. Also, a softer spool 11 such as urethane will allow the harder spool liner 12 to align concentrically with the plunger longitudinal centerline which better assures minimal friction and mitigates binding.

Although the urethane spool 11 is much easier to remove than the tungsten or stainless steel spools, it is still difficult to remove when employed in prior art designs. In the subject invention, and as specifically shown in FIG. 7, the body cavity 76 is modified to have a taper 79 (shown exaggerated for clarity). In practice, the taper is very slight, but permits the space between the spool and the cavity to increase as the spool is pulled from the body cavity thus reducing binding and rolling and allowing the spool to quickly and easily release. In addition, a taper, at the same angle as the mating inside surface of the body, can be utilized on the spool OD. This will further ease the release of the spool from the body. Specifically, the taper can be provided on the ID of the body cavity or both. Mated taper surfaces may also be used, which will minimize the clearance between components when the spool is fully seated, but permit the same beneficial results when the spool is withdrawn from the valve body.

The valve assembly of the subject invention also includes a modular plunger assembly 6, as best shown in FIGS. 5, 5a, 5b and 8. As is typical, when assembled in the valve, the plunger assembly 6 is axially movable along the central axis of the body (FIG. 5). In the subject invention the plunger assembly includes a central plunger core 6 having an outer diameter and made of a first material, and a plunger jacket 7 having an inner diameter of sufficient size to permit the jacket 7 to be placed in a surrounding relationship with the plunger core 6. There is at least one and preferably two removable seals 20 placed between the outer diameter of the plunger core and the inner diameter of the plunger jacket. In the example, there is a seal 20 placed at or near the top of the jacket 7 and a second seal 20 placed at or near the bottom of the jacket 7. The outer diameter of the plunger core and the inner diameter of the plunger jacket are sized such that the plunger jacket can be moved relative to the plunger core without substantial interference. Typically, the plunger jacket is constructed of a harder material than the plunger core. It may be desirable that one of the mated diameters of the plunger jacket and the plunger core is tapered to provide additional clearance therebetween. In some cases, it may be desirable that both the core and the jacket be tapered. This facilitates axial movement between the plunger jacket and the plunger core in one axial direction, specifically for replacement of the jacket on the core during assembly and maintenance. It is also desirable to provide a channel in the plunger core for receiving and seating each seal 20.

The upper portion of the plunger core 6 is of a larger outer diameter than the lower portion and is substantially similar to the outer diameter of the jacket 7 which is placed over the lower, lesser diameter of the plunger core. The top edge of the jacket 7 is positioned to provide a gap between the jacket and the upper portion of the plunger core. A washer seal 8 is placed in the gap. Typically, the seal 8 is a flexible, removable seal, such as, by way of example an o-ring seal. The removable seal has an outer diameter which is no smaller than the larger outer diameter of the plunger core 6.

In the preferred embodiment, the modular plunger assembly includes the core 6 and an outer plunger jacket 7. Typically, the jacket 7 is made of a hardened material such as tungsten carbide and the core 6 may be made of a much softer material, such as, by way of example, stainless steel. The jacket 7 is secured to and lines the core 6. In the example, the jacket 7 is secured to the core 6 by means of a fastener such as the retaining washer 10 and a threaded fastener such as the screw 17. The washer seal 8 is provided at the junction of the top of the sleeve and the core. Internal o-rings 20 are provided between the jacket 7 and the core 6.

In this configuration, the tungsten jacket 7 is adapted to slide over the stainless core 6 with three seals 20, 20 and 8 between them, held in place with a bolt or screw 17 and retaining washer 10. The retaining washer 10 may be flexible as will be explained. The tungsten (or otherwise hardened) jacket 7 can be removed and replaced onto the stainless (or softer) core 6. This will reduce the cost of the replacement part by reusing the stainless plunger shaft and core. In addition, the two o-rings 20, 20, resilient seal 8 and flexible washer 10 allow the jacket 7 to “float” and find its concentricity relative to the spool and spool liner. Although the float is small it prevents a bind due to misaligned or eccentric spool and plunger centerlines. Specifically, the subject invention improves performance and longevity of the valve design by permitting components to “float” or move relative to one another and self align, rather than being rigidly held.

Turning now to FIG. 9, as in FIGS. 1-8, the spool 11 is adapted to be received in the central bore 76 of the valve body 1, with the plunger 6 positioned in the central bore in communication with the spool assembly. The spool 11 is a substantially cylindrical member having an outer diameter adapted to be received in the central bore and an inner diameter adapted to receive the sleeve 12, see for example, FIG. 5B.

The sleeve or liner 12 has an outer diameter adapted to be received in the spool inner diameter and an inner diameter adapted to engage the plunger 6. The seal configuration is as generally shown in FIGS. 5a and 5b. There is at least one removable liner seal 21(see FIG. 5B) between the spool inner diameter and the liner outer diameter. In the preferred embodiment the liner seal 21 comprises an o-ring. Also, as shown, it may be desirable to include multiple seals 21. Typically, the spool liner includes a circumferential channel for receiving and seating each seal 21. In the embodiment of FIG. 9, the spool wiper comprises seals 23a and 23b placed in the spool 11 above and below the grit release gap 41. The spool wiper and the spool grit release gap work in conjunction to minimize the friction and extend the life of the plunger, as in the embodiment of FIGS. 1-8.

For the grit release gap 41 to be effective, there must also be at least one hard longitudinal surface to promote sliding and minimize friction. If there are two soft surfaces used to separate the plunger wipers, the grit could dig into the soft stainless inside diameter of the ring/spacer and the soft stainless outside surface of the plunger. This would result in progressively higher friction with continued use and could eventually bind. It is preferred to use a soft or softened secondary spool over the hardened portion of a plunger, basically achieving a hard and soft surface grit release gap where the soft surface is the secondary spool and the hard surface is on the plunger. Basically, there are four combinations for the grit release gap. The soft-to-soft combination is the least effective. Hard-to-soft is the most effective, whether the hard surface is on the spool and the soft surface is on the plunger, or vise versa. Hard-to-hard is also effective.

The spool 11 houses the wipers 23a, 23b and gap 99. The liner or sleeve 12 is positioned in the smaller ID of the spool as shown, with the wipers and gap in the ID of the spool above the liner. The soft spool wiper seals and gap are only in contact with the hard surfaces of the plunger at both extremes of plunger travel. An alternate configuration would permit a hard or hardened secondary sleeve placed around the soft stainless portion of the plunger, thereby effectively creating a hard to soft grit release gap combination which is the equivalent to the soft spool wiper configuration shown in the drawing. A second alternate grit release design may utilize a hard or hardened secondary jacket placed around the hard or hardened portion of the plunger. A tapered spool outer diameter and mating spool cavity may be utilized for ease of valve disassembly. It is also possible to taper only the spool cavity in the valve body and maintain a cylindrical spool outer diameter and still achieve improved disassembly features. This would permit retrofit of prior art designs having non-tapered spool cavities in the body of the valve.

Additional features of the embodiment of FIG. 9 include an elongated chamber 122 in the modified upper cap assembly 3. This chamber accommodates an extended portion of the spring 15 and minimizes bending of the spring axis as it is moved from the released position to the compressed position.

The mounting bolts 118 in the lower valve body 1 are through bolts, each secured by a nut 123 and pass through the through holes 119 and 120 in the lower valve body 1 and the base 2. This minimizes the collection of grit in the mounting holes and assures assembly without having to remove grit or other material trapped in the mounting holes. The abrasive inlet port 42a is tapered to minimize entrapment of abrasive material as it is introduced into the valve system.

FIG. 9 corresponds generally to FIGS. 4A and 4B and includes additional features further enhancing the performance of the valve, particularly the tapered, sectional spool and mated cavity in the lower housing, as well as additional sealing systems. These features may or may not be included in the valve without departing from the spirit of the novel features of the valve depicted in FIG. 9.

While certain features and embodiments have been described in detail herein, it will be understood that the invention encompasses all modifications and enhancements within the scope and spirit of the following claims.

1. A media control valve of the type comprising a body, a plunger assembly of multiple components housed in the body with a plunger control valve cap assembly secured to the body for housing a control knob, including resilient seals between adjacent multiple components of the plunger assembly to permit relative movement therebetween.

2. The media control valve of claim 1, wherein the valve body is of unitary construction.

3. A media control valve of the type comprising a body, a plunger assembly housed in the body with a plunger control valve cap assembly secured to the body for housing a control knob and control assembly, the media control valve further comprising: a flexible diaphragm positioned between the body and the valve cap assembly for controlling the flow of a fluid into the valve assembly.

4. The media control valve of claim 3, the media control valve further including a plate assembly mounted to the plunger assembly for securing the diaphragm to the plunger assembly in a manner permitting the plunger assembly to move with the diaphragm.

5. The media control valve of claim 4, wherein the plate assembly comprises an upper plate and a lower plate and wherein the perimeter of the diaphragm is sandwiched between the upper plate and lower plate.

6. The media control valve of claim 4, wherein the body is secured to the control valve cap assembly and wherein the perimeter of the diaphragm is sandwiched between the body and the plunger control valve cap assembly for securing the diaphragm in place when the media control valve is fully assembled.

7. A media control valve of the type having a body, a plunger assembly housed in the body with a plunger control valve cap assembly secured to the body for housing a control knob for limiting the movement of the plunger, the media control valve further comprising: a flexible diaphragm positioned between the body and the valve cap assembly, the valve cap assembly further including an adjustable knob assembly for controlling the movement limits of the plunger assembly, the media control valve further including a plate assembly mounted on the plunger assembly including an upper plate and a lower plate and wherein the diaphragm is sandwiched between the upper plate and lower plate for securing the diaphragm to the plunger assembly in a manner permitting the plunger assembly to move with the diaphragm, and wherein the body is secured to the plunger control valve cap assembly and wherein the perimeter of the diaphragm is sandwiched between the body and the plunger control valve cap assembly for securing the diaphragm in place when the media control valve is fully assembled.

8. A media control valve of the type having a body assembly, and a movable plunger housed in the body, the body having an control port, the valve further comprising: a flexible diaphragm positioned between the body and plunger and in communication with the control port, the flexible membrane and adapted for movement in response to flow of a control fluid through the control port.

9. The media control valve of claim 8, the body comprising a first housing section for a control knob assembly and a second housing section for housing the plunger assembly, wherein the diaphragm is sandwiched between the first housing section and the second housing section.

10. The media control valve of claim 9, wherein the control assembly is movable for controlling and limiting the movement of the plunger.

11. The media control valve of claim 10, further including a subassembly for securing the diaphragm to the plunger.

12. The media control valve of claim 11, wherein the subassembly comprises an upper plate and a lower plate, and wherein the center of the diaphragm is sandwiched between the upper plate and the lower plate.

13. A media control valve having a body for housing a movable plunger assembly, the body having a substantially central axis and the plunger assembly being axially movable along the central axis, the plunger assembly comprising:
a. A central plunger core having an outer diameter and made of a first material;
b. A plunger jacket having an inner diameter of sufficient size to permit the spool to be placed in a surrounding relationship with the plunger core.

14. The media control valve of claim 13, further comprising at least one removable seal between the outer diameter of the plunger core and the inner diameter of the plunger jacket.

15. The media control valve of claim 14, wherein the outer diameter of the plunger core and the inner diameter of the plunger jacket are sized such that the plunger jacket can be moved relative to the plunger core without interference.

16. The media control valve of claim 13, wherein the plunger jacket is constructed of a harder material than the plunger core.

17. The media control valve of claim 13, wherein one of said plunger jacket and said plunger core are tapered to provide additional clearance therebetween.

18. The media control valve of claim 13, wherein the inner diameter of the plunger jacket is tapered to generally mate with the taper on the plunger core.

19. The media control valve of claim 18, wherein the outer diameter of the plunger core is tapered to mate with the jacket taper.

20. The media control valve of claim 13, wherein the plunger jacket and plunger core are tapered to facilitate axial movement therebetween in a longitudinal axial direction.

21. The media control valve of claim 13, wherein the plunger jacket is tapered to facilitate axial movement between the plunger jacket and the plunger core in a longitudinal axial direction.

22. The media control valve of claim 13, wherein the plunger jacket is tapered to facilitate axial movement between the plunger jacket and the plunger core in one axial direction.

23. The media control valve of 13, wherein the seal comprising an o-ring seal between the inner diameter of the plunger jacket and the outer diameter of the plunger core.

24. The media control valve of claim 23, wherein the plunger core includes a circumferential channel for receiving the o-ring seal.

25. The media control valve of claim 23, including a plurality of o-ring seals placed along the axis of the plunger core.

26. The media control valve of claim 13, the plunger core having an first portion having outer diameter of a first diameter and a second portion having a second outer diameter which is smaller than the first diameter, the plunger jacket being adapted to be placed over the smaller second outer diameter.

27. The media control valve of claim 26, the plunger jacket including a top which is positioned to leave a gap between the top of the plunger jacket and the outer diameter first portion of the plunger core, and further including a removable seal positioned in the gap.

28. The media control valve of claim 27, wherein the removable seal has an outer diameter which is no smaller than the first outer diameter of the plunger core.

29. A plunger assembly for a media control valve, comprising:
a. An inner tapered, substantially cylindrical core made of a first material;
b. An outer tapered, substantially cylindrical jacket made of a second material;
c. At least one removable seal between the inner core and the outer jacket.

30. The plunger assembly of claim 29, wherein the inner cylindrical core has a stepped outer wall with a smaller portion adapted for receiving the jacket and a larger portion having an outer diameter substantially the same as the outer diameter of the jacket, with the jacket having an axial length such that there is a gap between the larger portion of the core and the top edge of the jacket, the plunger assembly further including a removable seal in the gap.

31. The plunger assembly of claim 30, wherein the seal has an outer diameter which is at least as large is the outer diameter of the larger portion of the plunger core.

32. A media control valve of the type having a body with a central bore and a spool positioned in the central bore and a plunger in the central bore internally of the spool, the media control valve comprising:
a. a substantially cylindrical spool in the bore, having an outer diameter adapted to be received in the central bore and an inner diameter;
b. a spool sleeve having an outer diameter adapted to be received in the spool inner diameter and the plunger outer diameter, the spool of a longer longitudinal length than the sleeve, wherein the portion of the spool outside the sleeve is of an intermediate inner diameter smaller then the outer diameter of the sleeve but larger than the inner diameter of the sleeve.

33. The media control valve of claim 32, further including at least one circumferential wiper seal mounted on the spool assembly and adapted for contacting the plunger.

34. the media control valve of claim 33, the valve further including a media inlet port in the body and in communication with the bore, the circumferential seal being positioned adjacent the media inlet port for minimizing a wedging action from accumulated media grit.

35. A spool assembly for a media control valve having a central bore, the spool assembly adapted to be received in the central bore of the media control valve, the spool assembly comprising:
a. a substantially cylindrical spool having an outer diameter adapted to be received in the central bore, and an inner diameter;
b. a spool sleeve having an outer diameter adapted to be received in the spool inner diameter and an inner diameter adapted to receive the plunger;
c. at least one removable sleeve seal between the spool sleeve inner diameter and the sleeve outer diameter, the spool of longer longitudinal length than the sleeve, wherein the portion of the spool outside the sleeve is of an intermediate inner diameter smaller than the outer diameter of the sleeve but larger than the inner diameter of the sleeve.

36. The media control valve of claim 35, further including at least one circumferential wiper seal adapted for contacting the plunger.

37. The media control valve of claim 35, wherein the central bore is tapered relative to the outer wall of the spool.

38. The media control valve of claim 35, wherein the outer wall of the spool sleeve is tapered relative to the central bore.

39. The media control valve of claim 35, wherein one of said outer wall of the spool and said central bore is tapered to provide additional clearance therebetween.

40. The media control valve of claim 39, wherein the inner diameter of the central bore is tapered.

41. The media control valve of claim 38, wherein the outer diameter of the spool sleeve is tapered in the same direction as the central bore.

42. The media control valve of claim 35, wherein the outer diameter of the spool and the inner diameter of the central bore are tapered to facilitate axial movement therebetween in a longitudinal axial direction.

43. A media control valve having a lower housing for containing a plunger having a substantially cylindrical outer diameter and adapted to be selectively axially positioned in the lower housing, an upper housing containing a diaphragm and a control system for controlling the axial position of the plunger in the housing, the valve comprising:
a. a spool assembly in the lower housing having at least one inner diameter engaging the outer diameter of the plunger in a sliding relationship;
b. the spool having at least a portion of which is of an inner diameter larger than the at least one inner diameter for defining a gap between the outer diameter of the plunger and the larger inside diameter portion of the spool, the larger inside diameter portion of the spool having axially spaced ends;
c. a wiper positioned at or near one of the axially spaced ends of the larger inside diameter portion of the spool for engaging and wiping the plunger as it is moved into position within the housing.

44. A media control valve having a lower housing for containing a plunger having a substantially cylindrical outer diameter and adapted to be selectively axially positioned in the lower housing, an upper housing containing a diaphragm and a control system for controlling the axial position of the plunger in the housing, the valve comprising:
a. a spool in the lower housing having at least one inner diameter engaging the outer diameter of the plunger in a sliding relationship;
b. the spool having at least a portion of which is of an inner diameter larger than the at least one inner diameter for defining a larger gap between the outer diameter of the plunger and the larger inside diameter portion of the spool, the larger inside diameter portion of the spool having axially spaced ends;
c. a first wiper seal positioned at or near one of the axially spaced ends of the larger diameter portion of the spool for engaging and wiping the plunger as it is moved into position within the housing;
d. a second wiper seal positioned at or near the other of the axial 1 y spaced ends of the larger inside diameter portion of the spool for engaging and wiping the plunger as it is moved into position within the housing above and below the release gap.

45. A media control valve having a lower housing for containing a plunger having a substantially cylindrical outer diameter and adapted to be selectively axially positioned in the lower housing, an upper housing containing a and a control system for controlling the axial position of the plunger in the housing, the valve comprising:
a. the plunger having an exterior surface of a first hardness; and
b. the spool having an interior surface of a second hardness and adapted for engaging the exterior surface of the plunger.

46. The media control valve of claim 45, wherein the first hardness is harder than the second hardness.

47. The media control valve of claim 45, wherein the first hardness is softer than the second hardness. 48 .The media control valve of claim 45, wherein the first hardness and the second hardness are the same.

49. The media control valve of claim 45, further comprising a sleeve surrounding the plunger and having an exterior surface which is of the first hardness.

50. The media control valve of claim 46, wherein the spool and sleeve are of the same hardness.

51. The media control valve of claim 45, wherein the spool is a removable element seated within the housing.

52. A media control valve having a lower housing for containing a plunger having a substantially cylindrical outer diameter and adapted to be selectively axially positioned in the lower housing, an upper housing containing a diaphragm and a control system for controlling the axial position of the plunger in the housing, the valve comprising:
a. the housing including an axially extending cavity;
b. a spool assembly adapted to be mounted in the cavity, the spool having at least one inner diameter engaging the outer diameter of the plunger, the cavity being tapered to facilitate axial movement of the spool in the cavity during assembly and disassembly.

53. The media control valve of claim 52, wherein both the spool and the cavity are tapered.

54. The media control valve of claim 52, wherein the spool is tapered.

55. A media control of the type having a body, a plunger assembly of multiple components housed in the body with a plunger control valve cap assembly secured to the body for housing a control knob, including resilient seals between adjacent of the multiple components of the plunger assembly to permit relative movement therebetween.

56. A media control valve of the type having a body, a plunger assembly housed in the body with a plunger control valve cap assembly secured to the body for housing a control knob and control assembly, the media control valve further comprising a flexible diaphragm positioned between the body and the valve cap assembly.

57. The media control valve of claim 56, the media control valve further including a plate assembly mounted to the plunger assembly for securing the diaphragm to the plunger assembly in a manner permitting the diaphragm to move the plunger assembly.

58. The media control-valve of claim 57, wherein the plate assembly comprises an upper plate and a lower plate and wherein the center of the diaphragm is sandwiched between the upper plate and lower plate.

59. The media control valve of claim 58, wherein the body is secured to the control valve cap assembly and wherein the perimeter of the diaphragm is sandwiched between the body and the plunger valve cap assembly for securing the diaphragm in place when the media control valve is fully assembled.
